(19) United States
(12) Patent Application Publication
(10) Pub. No.: US 2009/0277479 A1
(43) Pub. Date: Nov. 12, 2009

(54) Detonative Cleaning Apparatus

(76) Inventor: Kirk R. Lupkes, Renton, WA (US)

Correspondence Address: MCCORMICK, PAULDING & HUBER LLP, CITY PLACE II, 185 ASYLUM STREET, HARTFORD, CT, 06103, US

(21) Appl. No.: 12/118,071

(22) Filed: May 9, 2008

(51) Int. Cl. B08B 7/00

(52) U.S. Cl. 134/19; 122/379

(57) ABSTRACT

An apparatus for cleaning a surface within a vessel has a combustion conduit extending from an upstream end to a downstream end. The downstream end is associated with an aperture in the wall of the vessel and is positioned to direct a shockwave toward the surface. A source of fuel and oxidizer is coupled to the conduit to deliver the fuel and oxidizer to the conduit. An initiator is coupled to the conduit in position to initiate combustion of the fuel and oxidizer to form the shockwave. A buffer chamber is between the conduit and the source.

### BACKGROUND OF THE INVENTION

The disclosure relates to industrial equipment. More particularly, the disclosure relates to the detonative cleaning of industrial equipment.

Surface fouling is a major problem in industrial equipment. Such equipment includes furnaces (coal, oil, waste, etc.), boilers, gasifiers, reactors, heat exchangers, and the like. Typically the equipment involves a vessel containing internal heat transfer surfaces that are subjected to fouling by accumulating particulate such as soot, ash, minerals and other products and byproducts of combustion, more integrated buildup such as slag and/or fouling, and the like. Such particulate build-up may progressively interfere with plant operation, reducing efficiency and throughput and potentially causing damage. Cleaning of the equipment is therefore highly desirable and is attended by a number of relevant considerations. Often direct access to the fouled surfaces is difficult. Additionally, to maintain revenue it is desirable to minimize industrial equipment downtime and related costs associated with cleaning. A variety of cleaning technologies have been proposed. Such systems are often identified as “soot blowers” after an exemplary application for the technology.

A basic soot blower configuration is the steam lance soot blower. Additionally, combustion soot blower technologies have been proposed. Recent examples include those of U.S. Pat. No. 7,011,047 and US Patent Publication Nos. 2005/0126594, 2005/0130084, 2005/0125931, and 2005/0199743 the disclosures of which are incorporated by reference in their entireties herein as if set forth at length.

### SUMMARY OF THE INVENTION

One aspect of the disclosure involves an apparatus for cleaning a surface within a vessel. The apparatus has a combustion conduit having an outlet. The outlet is positioned to direct a shockwave toward the surface. The apparatus includes a source of fuel and oxidizer coupled to the conduit to deliver the fuel and oxidizer to the conduit. The apparatus includes an initiator coupled to the conduit and positioned to initiate combustion of the delivered fuel and oxidizer to form the shockwave. A buffer chamber is positioned between the conduit and the source and may provide means for preventing a flame propagation upstream from the conduit back to the source. In various implementations, there may be a fixed restriction between the conduit and the buffer chamber. The buffer chamber may have a volume of at least 5,000 cubic centimeters and a peak transverse cross-sectional area of at least 50 cm². The fuel and oxidizer may be delivered to the conduit as a fuel/oxidizer mixture (i.e., contrasted with separate delivery and formation of the mixture only in the conduit).

The apparatus may be operated by introducing the fuel/oxidizer mixture to the conduit through the buffer chamber and introducing a buffer gas to the buffer chamber. A reaction of the fuel/oxidizer mixture is initiated so as to, in turn, cause a detonation of the fuel/oxidizer mixture so as to cause the shockwave to impinge upon the surface. The reaction may comprise a deflagration-to-detonation transition.

In various implementations, the buffer gas may be different from the fuel/oxidizer mixture and from the fuel and oxidizer separately. The buffer gas may be a portion of a purge gas used to purge the conduit of combustion products of the fuel/oxidizer mixture. To complete the purge, a further portion of the purge gas may be introduced after the detonation. The further portion may drive the buffer gas into the combustion conduit as part of the purge.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a partially schematic view of soot blowers associated with an industrial furnace.

FIG. 2 is a partial side view of a soot blower of FIG. 1.

FIG. 3 is a view of an upstream end of the soot blower of FIG. 2.

FIG. 4 is partial sectional view of the soot blower of FIG. 2, taken along line 4-4.

FIG. 5 is a downstream end view of an injector of the soot blower of FIG. 2.

FIG. 6 is a longitudinal sectional view of the injector of FIG. 5, taken along line 6-6.

FIG. 7 is a partially schematic view of an additional soot blower.

FIG. 8 is a partially schematic view of an additional soot blower.

Like reference numbers and designations in the various drawings indicate like elements.

### DETAILED DESCRIPTION

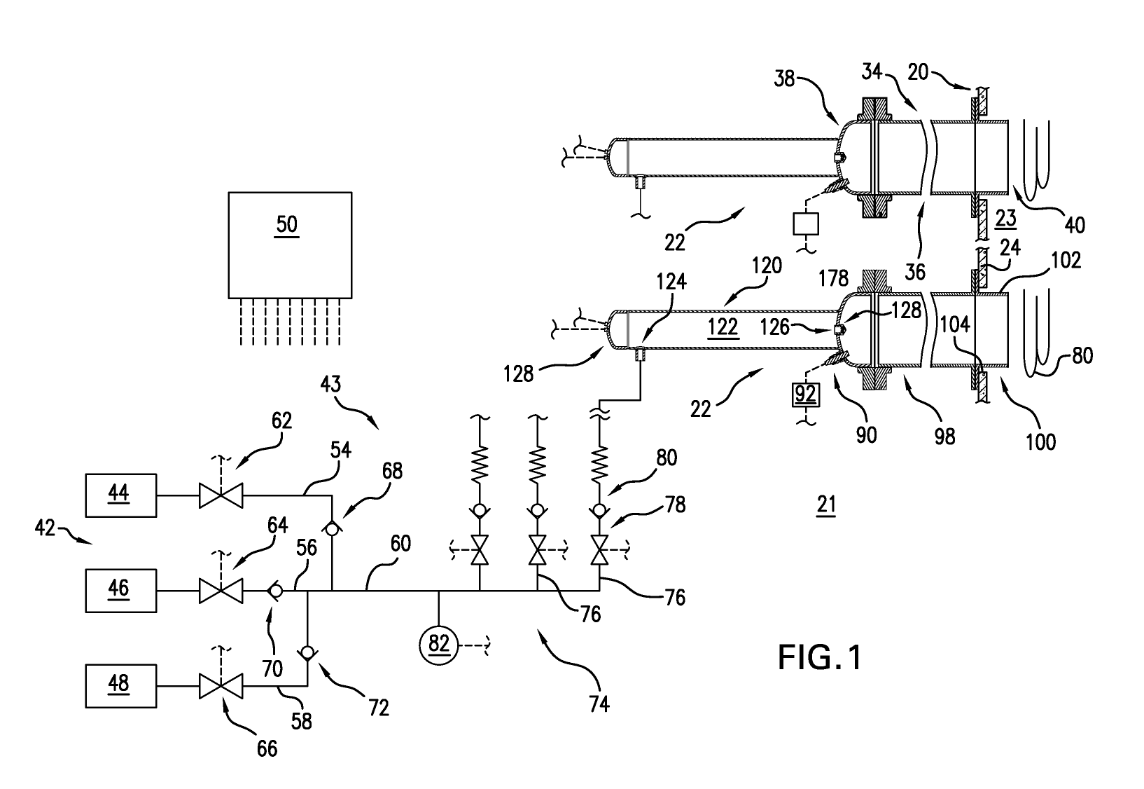

FIG. 1 shows a vessel (e.g., a boiler) 20 in a building 21. One or more soot blower apparatus (soot blowers) 22 are positioned to clean surfaces within the boiler interior 23. The exemplary boiler comprises a wall 24.

Each soot blower 22 includes a combustor 34 having an elongate combustion conduit 36 extending from a first (e.g., an upstream/distal/inlet end) 38 away from the boiler wall 24 to a second (e.g., downstream/proximal/outlet) end 40 closely associated with the wall 24. Optionally, however, the end 40 may be well within the boiler. In operation of each soot blower 22, combustion of a fuel/oxidizer mixture within the conduit 36 is initiated proximate the upstream end 38 (e.g., within an upstreammost 10% of a conduit length) to produce a detonation wave which is expelled from the downstream end 40 as a shockwave along with associated combustion gases for cleaning surfaces within the interior volume of the furnace.

Each soot blower 22 may be associated with a fuel/oxidizer source 42. Such source or one or more components thereof may be shared amongst the various soot blowers. In the illustrated example, a single source 42 is part of a single gas delivery system 43 shared by the various conduits 22. The exemplary source 42 includes a fuel source 44 and an oxidizer source 46 separate from the fuel source. An exemplary source 42 includes a liquified or compressed gaseous fuel cylinder 44 and an oxygen cylinder 46. As is discussed below, FIG. 1 also shows a purge/buffer gas source 48 separate from the oxidizer. An exemplary source 48 is a compressed air cylinder or an accumulator connected to a building air source (e.g., shop air).

In one example, there is a single fuel (e.g., propane) and a single oxidizer (e.g., pure oxygen). In a second example, the oxidizer is a first oxidizer such as essentially pure oxygen. A second oxidizer may be in the form of air delivered from the air source 48. The first and second oxidizers may be used to deliver a two-stage charge: a high detonable charge including the pure oxygen; and a less detonable charge containing the air (the highly detonable charge being used to detonate the less detonable charge). The source 42 may be controlled and monitored by a control and monitoring system 50 (controller). An exemplary controller 50 may include a computer or microcontroller appropriately programmed via one or both of hardware and software.

The sources 42 (44, 46) and 48 are coupled to the various conduits by appropriate plumbing. In the illustrated example, the sources 44, 46, and 48 are coupled via upstream root branches 54, 56, and 58 joining in a mixing line 60. In each of the roots 54, 56, and 58, there is a selector valve 62, 64, 66 upstream and a one-way check valve 68, 70, 72 downstream (oriented to prevent upstream flow). The selector valves 62, 64, 66 may be coupled via appropriate power and/or signal lines to the controller 50 to be selectively opened and closed by the controller 50. A distribution manifold 74 is at a downstream end of the mixing line 60. The distribution manifold 74 divides flow into separate branches 76 (distribution lines) for individual combustors or individual groups of combustors. In the illustrated example, a selector valve 78 and a one-way check valve 80 (oriented to prevent upstream flow) are positioned in each distribution line 76. The selector valves 78 are also coupled to the controller 50. In the illustrated example, a pressure sensor 82 is positioned along the mixing line 60 and coupled to the controller 50.

There are also means for igniting or initiating combustion. In the illustrated example, the means for initiating or igniting includes an initiator/igniter 90 for each combustor. In the example, each igniter 90 is connected to an associated spark box 92 which is in turn coupled to the controller 50. There may be one or more separate power sources (not shown) for powering the spark boxes, selector valves, and other components.

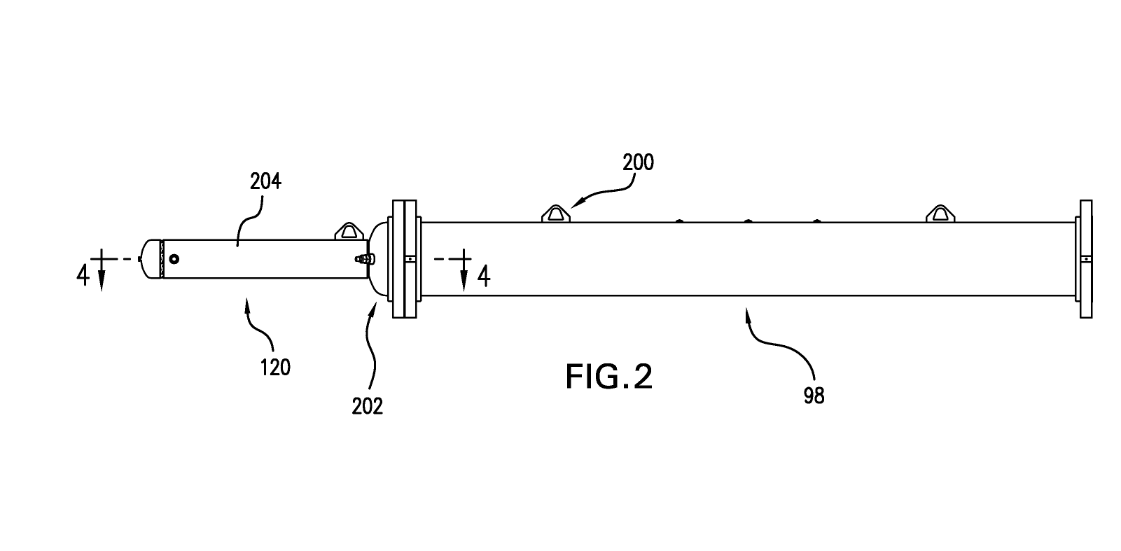

FIG. 1 shows further details of an exemplary soot blower 22. The exemplary conduit 36 may be formed by a series of doubly flanged conduit sections or segments 98 arrayed from upstream to downstream and a downstream nozzle conduit section or segment 100 having a downstream portion 102 extending through an aperture 104 in the wall 24 and ending in the downstream end or outlet 40 exposed to the vessel interior 23. The term “nozzle” is used broadly and does not require the presence of any aerodynamic contraction, expansion, or combination thereof. Exemplary conduit segment material is metallic (e.g., stainless steel). The outlet 40 may be located further within the vessel (e.g., if appropriate support and cooling are provided). FIG. 2 further shows furnace interior tube bundles 80, the exterior surfaces of which are subject to fouling and which are to be cleaned by the soot blower 22.

Means are provided for isolating the gas delivery system (or at least upstream components thereof which might otherwise be subject to damage) from the combustor and its combustion and detonation. The exemplary means for isolating includes one or more buffer chambers. In the FIG. 1 example, there are a plurality of buffer chambers 120 each respectively associated with a corresponding combustor 34. Each buffer chamber 120 includes an interior space or volume 122. The buffer chamber 120 has an inlet 124 (inlet port) and an outlet 126 (outlet port). In the FIG. 1 example, the outlet 126 essentially also forms an inlet of the conduit 36. The exemplary inlet 124 is formed near an end 128 of the buffer chamber 122 remote of the combustor. The inlet 124 is coupled to a downstream end of an associated delivery line 76. As is discussed further below, at firing, the buffer chamber contains a sufficient volume of a sufficiently inert composition (or sufficiently inerting gradient) over a sufficient distance from the combustor to avoid the firing of the combustor delivering excessive pressure or temperature to sensitive components of the system 43 upstream. As is discussed further below, in the FIG. 1 example, the buffer chamber outlet 126 is essentially also the combustor inlet and is defined by an injector 128. The injector 128 presents a substantial flow restriction effective to aid in isolation of the buffer chamber from the combustor upon firing.

In operation, at the beginning of a use cycle of a given combustor 34, the combustion conduit 36 is initially empty except for the presence of air (or other purge gas or flue gas or other residual gas as discussed below). The controller 50 controls the selector valves 62 and 64 to deliver fuel and oxidizer to the mixing tube 60 where they mix to form a fuel/oxidizer charge. The appropriate selector valve(s) 78 are opened by the controller to deliver the charge through the appropriate delivery line(s) 76 to the appropriate conduit(s). The fuel/oxidizer mixture passes into the buffer chamber through the inlet 124, filling the buffer chamber(s) 20 and then passing through the injector 128 into the conduit 36. During this passage, the fuel/oxidizer mixture may drive the residual gas ahead of the fuel/oxidizer mixture, there being an interface (a first interface) between the residual gas and the fuel/oxidizer mixture.

When an appropriate amount of fuel and oxidizer have been supplied by the fuel and oxidizer sources, the respective source selector valves 62 and 64 are closed by the controller 50 and the air source selector valve 66 is opened, introducing air to the mixing line 60. This will form an interface (a second interface) between the air and the fuel/oxidizer mixture. The flow of air will drive this second interface downstream through the distribution manifold 74, and delivery line(s) 76 and into the buffer chamber. This will drive more of the fuel/oxidizer mixture into the conduit through the injector.

Eventually, a desired ignition/firing condition will be achieved. This is achieved when sufficient air has reached the buffer chamber to provide the buffer function (discussed below) yet the fuel/air mixture in the conduit 36 is sufficient to properly ignite and, in turn, detonate.

Prior to firing, the air source selector valve 66 and the appropriate selector valve(s) 78 are closed. Although the closing may be simultaneous, it may be advantageous to close the valve 66 slightly before the valve(s) 78 to minimize pressure in the mixing line 60. With the selector valve(s) 78 of the about-to-fire combustor(s) closed, the controller may trigger the associated spark box 92 to provide a spark discharge of the initiator 90 igniting charge (or the predetonator charge in a multi-charge example). The initial deflagration of the charge quickly transitions to a detonation, producing a detonation wave. Once such a detonation wave occurs, it is effective to pass through the rest of the charge (or the main charge (in a multi-charge example) which might, otherwise, have sufficiently slow chemistry to not detonate within the conduit of its own accord). The wave passes longitudinally downstream and emerges from the downstream end 40 as a shockwave within the furnace interior, impinging upon the surfaces to be cleaned and thermally and mechanically shocking to typically at least loosen the contamination. The wave will be followed by the expulsion of pressurized combustion products from the detonation conduit, the expelled products emerging as a jet from the downstream end 40 and further completing the cleaning process (e.g., removing the loosened material).

Upon initiation/firing, the gas contained in the buffer chamber 120 advantageously has appropriate composition and distribution to prevent a detonation wave from passing upstream through the buffer chamber and into the delivery line 76 (thus avoiding damaging upstream components including avoiding igniting fuel at the fuel source). It is expected that, at initiation/firing, there will be some fuel and oxidizer in the buffer chamber, particularly toward the downstream end near the outlet 126. This is because the second interface will tend to smear, locally diluting the fuel/oxidizer mixture with air. However, the conduit 36 must have sufficient fuel and oxidizer at the initiator 90 to initiate combustion. Accordingly, it may be necessary that most of the smeared second interface be contained within the buffer chamber. The buffer chamber has sufficient volume and length to sufficiently dilute the overall content of fuel and oxidizer in the buffer chamber and sufficiently isolate the fuel and oxidizer toward the downstream end. The restriction provided by the injector 128 is also effective to limit/control backpressure or backflow from the detonation to within tolerable margins. The result is that the delivery line 76 and upstream components will experience only a tolerable pressure pulse and temperature increase.

The air selector valve 66 may be reopened, pressurizing the mixing tube 60 with air. This pressurization may be detected by the pressure sensor 82. An exemplary sensor 82 is a simple pressure switch with a threshold corresponding to a predetermined sufficient air pressure. If sufficient pressure is not determined, the controller 50 may determine an error condition and cease further operation of the combustors and signal for assistance/maintenance.

If, however, sufficient pressure is determined, the controller 50 may then reclose the air valve 66. The controller 50 may then reopen the appropriate valve(s) 78. The opening of the valve(s) 78 bleeds pressurized air from the mixing tube into the delivery line(s) and buffer chamber(s). Sufficient completion of this bleed may be measured by the pressure sensor 82. When the bleed has occurred, the fuel and oxidizer source selector valves 62 and 64 may be reopened as the start of the next cycle.

As a variation, after or overlapping the venting of combustion products, a purge gas (e.g., air from the source 48) may be introduced through the buffer chamber 120 to drive the final combustion products out and leave the buffer chamber 120 and conduit 36 filled with purge gas ready to repeat the cycle (either immediately or at a subsequent regular interval or at a subsequent irregular interval (which may be manually or automatically determined by the control and monitoring system)). As another variation, a baseline flow of the air may be maintained between charge/discharge cycles so as to prevent gas and particulate from the furnace interior from infiltrating upstream and to assist in cooling of the detonation conduit. Thus, in various combinations, the purge gas, residual combustion product and/or flue gas may provide the residual gas which is driven out by the fuel/oxidizer mix of the next firing cycle.

Various means may be provided for monitoring combustor performance. Monitored or determined (e.g., calculated) parameters may include verification of detonation and sufficiency of power on the one hand and safety margin on the other hand. FIG. 1 shows a motion sensor 150 mounted to an exterior surface of the buffer conduit. FIG. 1 also shows a temperature sensor 152. Both sensors may be coupled to the controller 50. An exemplary motion sensor 150 is a contact accelerometer. An exemplary contact accelerometer is a piezoelectric sensor such as ceramic shear accelerometer. An exemplary temperature sensor 152 is a thermocouple penetrating into the interior of the buffer chamber.

After firing, sufficiency of the output of the motion sensor 150 may be used by the controller 50 to confirm detonation and confirm sufficiency of associated combustor shockwave power. The temperature sensor 152 may be used to verify non-excessive temperature. For example, the temperature sensor 152 may be positioned near the buffer chamber inlet 124. An excessive temperature measured near the buffer chamber inlet 124 may indicate that there was too much fuel (or fuel/oxidizer mixture) in the buffer chamber, generally, or at least in the upstream end near the inlet. Responsive to an excessive temperature, the controller 50 may alter timing or other parameters for the next shot/firing. For example, the controller 50 might cause the next shot of the combustor to occur only after more air has been introduced to drive the second interface further downstream. However, if temperature is within the acceptable range, and a failure of detonation or insufficiency of detonation power is detected (via the motion sensor 152), less air could be introduced for the next shot/firing to increase the likely detonation power. More complex control variations and/or systems are possible. For example, other sensors and control variations are disclosed in commonly owned U.S. patent application Ser. No. 11/740,413, filed Apr. 26, 2007.

The apparatus may be used in a wide variety of applications. By way of example, just within a typical coal-fired furnace, the apparatus may be applied to: the pendants or secondary superheaters, the convective pass (primary superheaters and the economizer bundles); air preheaters; selective catalyst removers (SCR) scrubbers; the baghouse or electrostatic precipitator; economizer hoppers; ash or other heat/accumulations whether on heat transfer surfaces or elsewhere, and the like. Similar possibilities exist within other applications including oil-fired furnaces, black liquor recovery boilers, biomass boilers, waste reclamation burners (trash burners), and the like.

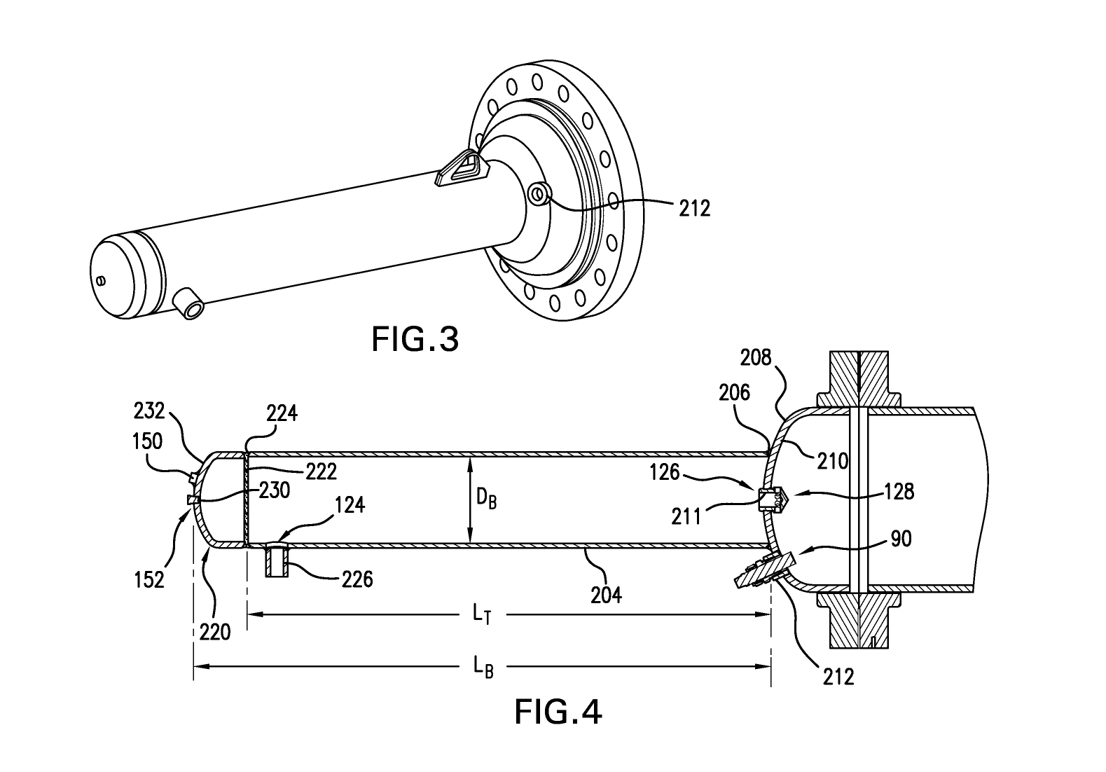

FIGS. 2-6 show further details of the exemplary combustor and buffer chamber. FIG. 2 shows the most upstream of the segments 98 and the buffer chamber 120 each having one or more lugs/eyelets 200 for suspending the combustor from a fixed structure of the building. The upstream end of the exemplary conduit 36 is formed by a flanged domed cover 202 bolted to the upstream flange of the upstreammost of the segments 98. The exemplary buffer chamber 120 comprises a tube 204 having a downstream end/rim 206 welded to an exterior surface 208 of the dome 210 of the cover 202. The dome 210 has a central aperture 211 into which the injector 128 is mounted. The exemplary aperture 211 is internally threaded to mate with an external thread of the injector 128. The igniter 90 is also mounted in an aperture in the dome via a boss or half coupling 212.

The buffer chamber 120 includes a domed cap 220 having a rim 222 welded to an upstream rim 224 of the tube 204. The buffer chamber inlet 124 is formed at a boss 226 which mates with the associated delivery line 76. The exemplary cap 220 includes a central aperture 230 accommodating the temperature sensor 152. The exemplary motion sensor 150 is mounted to the exterior surface 232 of the cap 220. The exemplary buffer chamber has an overall internal length L_{B} and an internal diameter D_{B}. A flowpath length from the inlet 124 to the outlet 126 may be close to L_{B} (e.g., at least 75%).

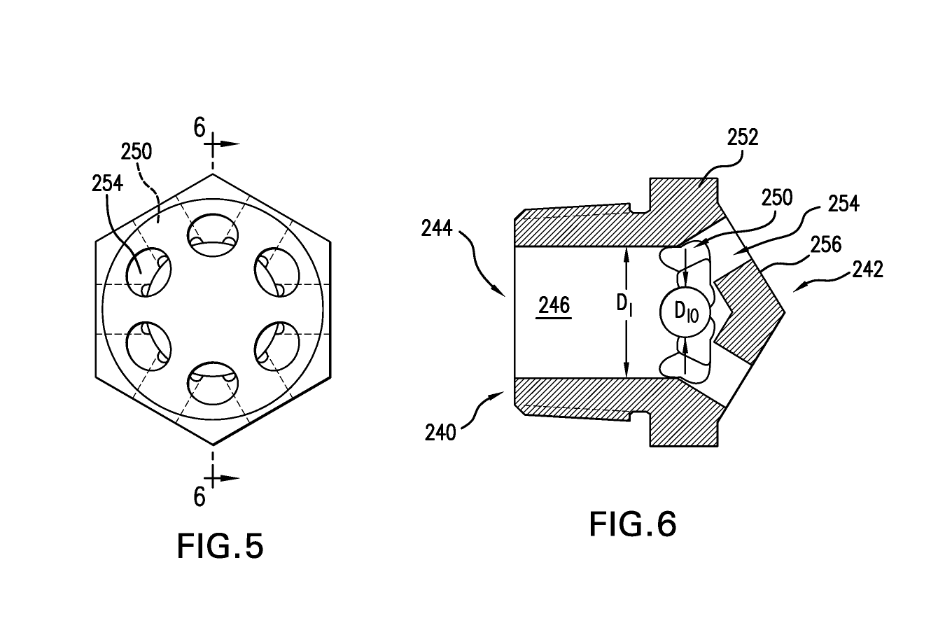

FIGS. 5 and 6 show details of the exemplary injector. The exemplary injector comprises a single-piece metal body having an upstream end 240 and a downstream end 242. The upstream end may be formed by a rim surrounding the inlet 244 to a passageway 246. The exemplary passageway 246 is at least partially formed as a bore of diameter D_{I}. The exemplary bore extends from the upstream end 240 but terminates short of the downstream end. To provide an outlet from the injector, the injector includes a plurality of apertures. The exemplary apertures include exemplary ring of lateral bores 250 extending radially outward to the periphery of a flange 252. In the illustrated example, the flange is of hexagonal section with one bore extending centrally to each facet of the flange. A second group of bores 254 are angled to intersect a frustoconical downstream face 256. The exemplary bores 250 and 254 have diameters D_{IO}. As noted above, the overall restriction provided by the injector helps isolate the buffer chamber and the upstream components from the effects of detonation. Furthermore, the division and orientation of the bores 250 and 254 also provides isolation.

Exemplary combustor materials include stainless steel. An exemplary tube 204 is formed of 6″ outer diameter (OD) stock having an inner diameter (ID) of 5.136″ (13.05 cm) and a length L_{T} of 36″ (91 cm). The exemplary cap 220 adds less than 10% to the associated tube volume of 746 inch³ (12,222 cm³). More broadly, the exemplary buffer chamber may have a volume of at least 5,000 cm³ (e.g., 5,000-20,000) or greater than 10,000 cm³ (e.g., 10,000-15,000). The exemplary peak cross-sectional area is 20.7 in² (134 cm²). More broadly, exemplary cross-sectional area is at least 50 cm² (e.g., 50-200) or at least 100 (e.g., 100-150). An exemplary flowpath length from the inlet 124 to the outlet 126 is at least 50 cm (e.g., 50-200 cm).

By contrast, the characteristic cross-sectional area of the restriction (injector) may be much smaller than that of the buffer chamber and the characteristic cross-sectional area of the combustor may be much larger. The exemplary injector ID B_{I} is 1.0″ (2.54 cm) for a cross-sectional area of 0.785 in² (10.44 cm²). Exemplary injector outlet diameters D_{IO} are 0.375″ (0.95 cm) for an individual cross-sectional area of 0.11 in² (0.713 cm²) and an overall cross-sectional area of 8.55 cm². The effective fluidic restriction of the outlets is equivalent to a single circular hole having less than that total cross-sectional area. Exemplary total cross-sectional area is less than 10% that of the buffer chamber.

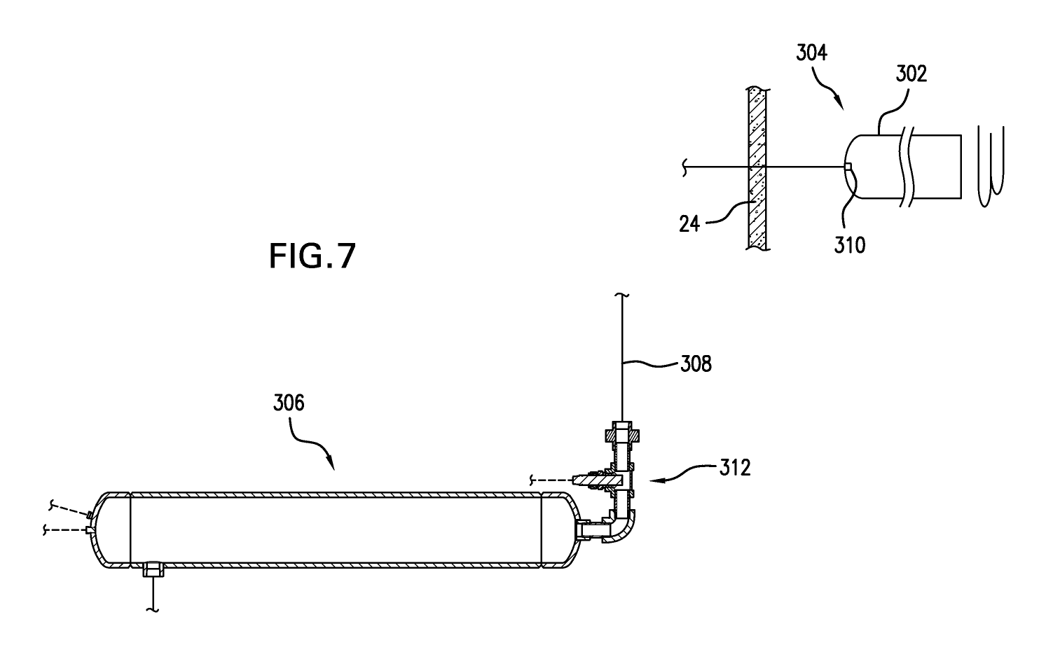

FIG. 7 shows a soot blower 300 wherein a main body 302 of the combustor 304 is located within the vessel interior. The buffer chamber 306 is outside the vessel and may be similarly formed to the chamber 120 but, for example, with a downstream end cap coupled to a combustor inlet line 308. The combustor inlet line 308 extends through the wall to an injector 310 in the combustor. The exemplary injector 310 may be similarly formed to the injector 128. An exemplary initiator/igniter 312 is positioned along the combustor inlet line 308 outside the vessel. Other details of gas delivery, control, and monitoring, may be as noted above or otherwise. Compared/contrasted with the embodiment of FIG. 2, the FIG. 7 embodiment reverses the relative upstream/downstream positions of the injector and initiator/igniter. Control over gas delivery (e.g., fuel/oxidizer and buffer or purge gas) may, however, be similarly timed so that there is sufficient fuel and oxidizer at the initiator/igniter upon firing to produce a desired detonation and shockwave discharge while there is also sufficiently little fuel and/or oxidizer or a sufficiently decaying gradient upstream of the initiator/igniter so that the buffer chamber can serve its buffering/isolation functions. Buffer chamber volume may be measured upstream of the buffer chamber outlet to the combustor inlet line 308. The combustor inlet line 308 may effectively also serve as the flow restriction between the buffer chamber and the conduit.

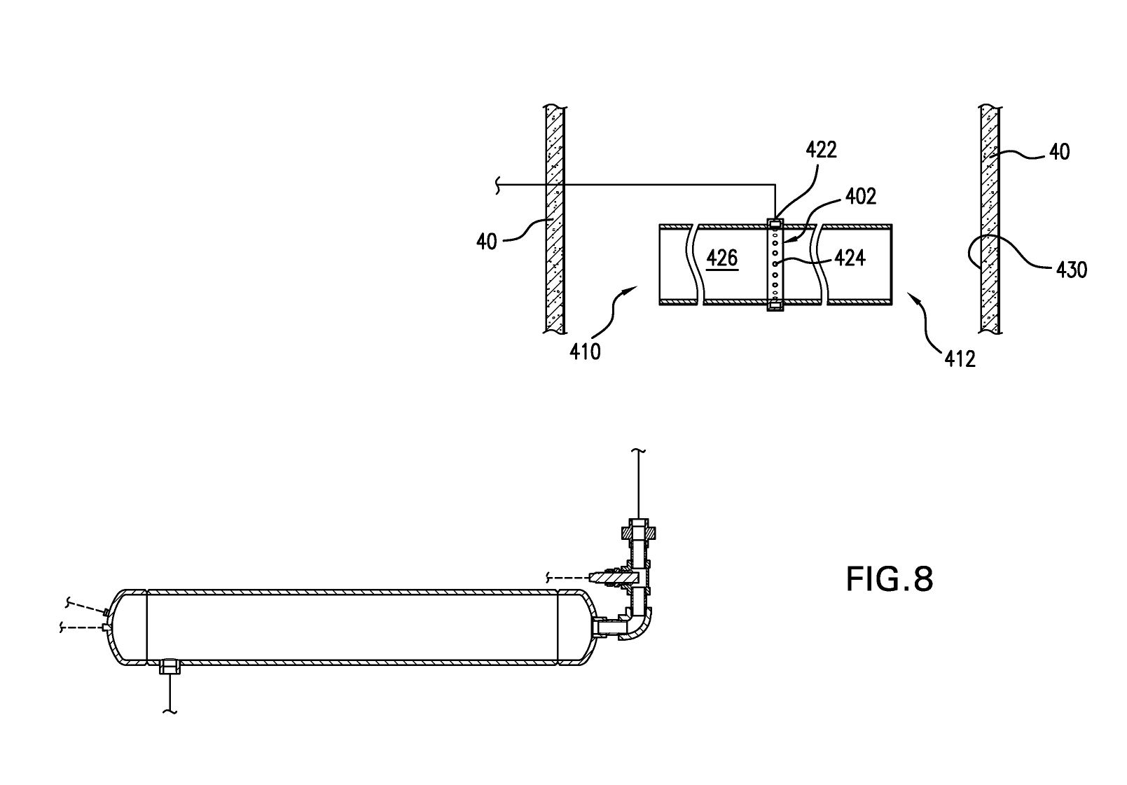

FIG. 8 shows a soot blower 400. The exemplary soot blower 400 may be similar to the soot blower 300 except for the combustor inlet/injector 402 being centrally or at least intermediately positioned along a tube 404 of the combustion conduit 406 between multiple outlets (e.g., a pair of axially opposite outlets 410 and 412 facing away from each other). The opposite outlets essentially eliminate thrust loads making it easier to mount within the vessel. The exemplary injector 402 is formed as a plenum/manifold circumscribing the perimeter of the tube 404 and having a manifold inlet 422 and a plurality of individual manifold outlets 424 to the tube interior 426. The illustrated positioning of the outlets 410 and 412 directs their output to clean an interior surface 430 along opposite sections of the wall 40. Such a configuration may, for example, be useful in exhaust ducts along an exhaust gas flowpath from a main boiler, furnace, or other vessel.

One or more embodiments of the present invention have been described. Nevertheless, it will be understood that various modifications may be made without departing from the spirit and scope of the invention. For example, the invention may be adapted for use with a variety of industrial equipment and with variety of soot blower technologies. Aspects of the existing equipment and technologies may influence aspects of any particular implementation. Accordingly, other embodiments are within the scope of the following claims.

What is claimed is:

1. An apparatus for cleaning a surface within a vessel, the apparatus comprising:
a combustion conduit having at least one outlet positioned to direct a shockwave toward said surface;
a source of fuel and oxidizer coupled to the conduit to deliver the fuel and oxidizer to the conduit;
an initiator coupled to the conduit and positioned to initiate combustion of the fuel and oxidizer to form the shockwave; and
a buffer chamber between the conduit and the source.

2. The apparatus of claim 1 wherein:
the initiator is positioned outside of a wall of the vessel; and
at least 50% of a total volume of the combustion conduit is within the vessel.

3. The apparatus of claim 1 further comprising:
a restriction between the conduit and the buffer chamber.

4. The apparatus of claim 3 wherein:
the restriction has an effective cross-sectional flow area of less than 10% of at least one cross-sectional flowpath area of the buffer chamber.

5. The apparatus of claim 4 wherein:
the restriction comprises a plurality of apertures each having individual cross-sectional areas of 30-150 mm² and a combined cross-sectional area of 400-2,000 mm²;
the buffer chamber has a volume of 5,000-20,000 cubic centimeters; and
the buffer chamber has:
an inlet port; and
a flowpath length from the inlet port to the restriction of 50-200 cm.

6. The apparatus of claim 1 wherein:
there are a plurality of said conduits and a plurality of said buffer chambers, each said conduit respectively associated with a different single said buffer chamber; and
the source of fuel and oxidizer comprises a distribution manifold common to the plurality of conduits.

7. The apparatus of claim 6 wherein:
a flowpath length from the manifold to at least one of the conduits is in excess of 10 m.

8. The apparatus of claim 6 wherein the source comprises:
a fuel vessel containing said fuel;
an oxidizer vessel containing said oxidizer.

9. The apparatus of claim 8 wherein the source comprises:
a mixing line upstream of the manifold.

10. The apparatus of claim 8 further comprising:
a controller; and
a plurality of selector valves, each of the selector valves coupled to the control system to be selectively opened and closed and respectively associated with a different said conduit so as to provide independent control of flow of the fuel and oxidizer to said conduits.

11. The apparatus of claim 6 further comprising:
a source of a buffer gas distinct from said oxidizer, and upstream of the distribution manifold.

12. The apparatus of claim 1 wherein:
an air source is coupled to the buffer chamber.

13. The apparatus of claim 12 wherein the buffer chamber has:
a volume of at least 5,000 cubic centimeters; and
a peak cross-sectional area of at least 50 cm².

14. The apparatus of claim 13 wherein:
the volume is at least 10,000 cubic centimeters.

15. The apparatus of claim 14 wherein:
the peak cross-sectional area is at least 100 cm².

16. An apparatus for cleaning a surface within a vessel, the apparatus comprising:
an elongate combustion conduit having an outlet positioned to direct a shockwave toward said surface;
a source of fuel and oxidizer coupled to the conduit to deliver the fuel and oxidizer to the conduit;
an initiator coupled to the conduit and positioned to initiate combustion of the fuel and oxidizer to form the shockwave; and
means for preventing a flame propagation from said conduit upstream to said source.

17. The apparatus of claim 16 wherein:
the means prevent a detonation wave from said conduit from passing upstream to said source.

18. The apparatus of claim 16 wherein:
the means comprises a buffer chamber having:
a volume of at least 5,000 cubic centimeters; and
a peak cross-sectional area of at least 50 cm².

19. The apparatus of claim 16 further comprising:
an air source coupled to the conduit to deliver air to the means for preventing the flame propagation.

20. The apparatus of claim 19 wherein:
the fuel and oxidizer comprises a source of fuel and a source of oxidizer; and
the source of fuel, the source of oxidizer, and the source of air are coupled in parallel upstream of a distribution manifold, the distribution manifold, in turn, coupled to a plurality of said elongate combustion conduits.

21. A method for cleaning a surface within a vessel, the vessel having a wall with an aperture therein, the method comprising:
introducing a fuel/oxidizer mixture to a conduit;
introducing a buffer gas to a buffer chamber between the conduit and a source of the fuel/oxidizer mixture; and
initiating a reaction of the fuel/oxidizer mixture so as to, in turn, cause a detonation of the fuel/oxidizer mixture so as to cause a shockwave to impinge upon the surface;

22. The method of claim 21 wherein:
the initiating occurs downstream of the buffer chamber; and
at least 95% of the fuel combusts downstream of the buffer chamber.

23. The method of claim 21 wherein:
the reaction of the fuel/oxidizer mixture comprises a deflagration-to-detonation transition.

24. The method of claim 21 further comprising:
purging the conduit of combustion products of the fuel/oxidizer mixture with a purge gas,
wherein:
the buffer gas is a portion of the purge gas, a further portion of the purge gas being introduced after the detonation.

25. The method of claim 21 wherein:
the fuel/oxidizer mixture is introduced premixed to the conduit.

26. The method of claim 21 wherein:
the first fuel/oxidizer mixture is introduced premixed to the first conduit portion; and the second fuel/oxidizer mixture is introduced premixed to the second conduit portion.

27. The method of claim 21 wherein:
there are a plurality of said conduits;
the fuel/oxidizer mixture is delivered from the fuel/oxidizer source to the plurality of conduits via a distribution manifold;
there are a plurality of said buffer chambers, respectively associated with the plurality of conduits, each buffer chamber between the associated conduit and the distribution manifold; and
the introduction of the buffer gas to each of the buffer chambers is effective to prevent a detonation wave from said conduit from passing upstream to said manifold.

28. The method of claim 27 wherein:
the fuel/oxidizer source comprises a vessel containing a hydrocarbon fuel as said fuel and a second vessel essentially containing pure oxygen; and
the buffer gas consists essentially of air.

29. The method of claim 21 wherein:
the introducing of the fuel/oxidizer mixture comprises passing the fuel/oxidizer mixture through a restriction between the buffer chamber and the conduit.
